(19) United States
(12) Patent Application Publication
(10) Pub. No.: US 2026/0064512 A1
(43) Pub. Date: Mar. 5, 2026

(54) METHOD AND SYSTEM FOR DYNAMICALLY RENDERING A DASHBOARD LAYOUT

(71) Applicant: Honeywell International Inc., Charlotte, NC (US)

(72) Inventors: Ankit Singh, Apex, NC (US); Lakshminarayana Paila, Frisco, TX (US)

(21) Appl. No.: 18/824,959

(22) Filed: Sep. 5, 2024

(51) Int. Cl. G06F 11/07; G06F 3/04817

(52) U.S. Cl. CPC G06F 11/0781; G06F 3/04817

(57) ABSTRACT

The present disclosure provides a method and system for rendering a dashboard layout to a user in a business enterprise. The method comprises receiving authentication credentials from the user. The method further comprises retrieving a profile of the user based on the authentication credentials, wherein the profile includes at least one of a user identifier, an identifier of the business enterprise, a role of the user in the business enterprise. The method further comprises identifying one or more widgets based on the profile of the user. The method further comprises retrieving data associated with the one or more widgets, wherein the data for each of the one or more widgets comprises at least one of a user preference rating, information on historical interactions, a score based on historical data. The method further comprises selecting the one or more widgets based on a combination of the profile of the user and the data associated with the one or more widgets and further dynamically rendering the dashboard layout with the selected widgets. A system for rendering a dashboard layout to a user in a business enterprise is also disclosed.

### TECHNICAL FIELD

Embodiments of the present disclosure generally relate to document management systems for business enterprises. Particularly, the present disclosure relates to a method and system for providing a dashboard generation system that enables dynamic rendition of dashboard layout to users of business enterprises.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Business enterprises or organizations may typically handle large amounts of data and information for planning and managing their business operations. Each enterprise may have thousands of users or employees who manage their day-to-day operations to achieve certain business goals or outcomes. In a non-liming example, the various business operations may include processes like Annual Product Quality Review, Quality System Management Review, Product Recall, Knowledge Management Review, Design Control, regulatory compliance, supply chain problems, etc. which may serve various industries like Pharma, Life Sciences, Bio Tech, Med Devices industries, among others. Typically, the enterprises may manage and monitor such example business operations using document management systems (DMS). The document management systems enable storing complex documentations including manufacturing documents, design documents, process documents, SOPs, etc.

As businesses evolve, the volume of data and information that needs to be handled increases manifold so does the complexity with monitoring, managing and maintaining data in a reliable and efficient manner. For example, for large business enterprises, the data that is manipulated is real-time or near-real-time, is voluminous and there is also a rapid rate of change of data. Therefore, there arises a need to not only monitor the data from different sources but also identify data issues with any services or applications provided by the business enterprises and debug the errors to resolve the data issues in a timely manner.

Typically, user interfaces such as dashboards are used by business entities (enterprises or organizations) to monitor and observe data and metrics from different data sources, identify the source of errors and debug the errors. The goal of these dashboards is to capture errors and problem scenarios in relation to business operations by providing interactive data visualizations. However, not all dashboards reflect a particular error. Some visualizations may have indications of the errors while others may not reflect the errors precisely. As the operational complexity of businesses increases in a dynamic business environment, multiple dashboards may have to be used for debugging and resolving the errors, making it complex and cumbersome for users to understand which dashboard to refer to fix problems and debug errors.

Effective monitoring and observability of data is essential to quickly resolve errors and issues encountered in business operations and to ensure the quality, reliability, accuracy of data in the enterprise. Therefore, monitoring or observability dashboards that are utilized by the business entities need to be dynamic and customized in order for the users to quickly understand the cause of an error and resolve problem scenarios. By providing observability dashboards that are dynamic and customized to meet specific requirements of the customer, enterprises can achieve an efficient framework for data observability, which ensures the overall health and performance of the system and also helps in business analytics.

Accordingly, there is a need for technical solutions to address the technical problems discussed above, and other inefficiencies of the prior arts. Particularly, there is a need to monitor, observe and manage the data from various sources in an enterprise and dynamically render a dashboard layout to user that is tailored to user requirements.

The legacy approaches fail to provide efficient techniques for document management systems for business enterprises. The present disclosure aims to provide a method and system for dashboard generation that enables dynamic rendition of dashboard layout to users to enable quick and efficient debugging of errors and problems encountered in data pipelines across the enterprise.

Applicant has identified many technical challenges and difficulties associated with current solutions and through applied effort, ingenuity, and innovation, the applicant has provided a solution to the above-mentioned drawbacks.

### SUMMARY OF THE INVENTION

In general, embodiments of the present disclosure relate to providing efficient techniques for document management systems for business enterprises. Other implementations will be, or will become, apparent to one with skill in the art upon examination of the following figures and detailed description. It is intended that all such additional implementations be included within this description be within the scope of the disclosure and be protected within the scope of the following claims.

The present disclosure provides techniques for monitoring and managing dynamic work environments of business enterprises. Specifically, the present disclosure provides a method and system for dynamically rendering a dashboard layout to a user in an enterprise setting. According to the present disclosure, the users of an enterprise may track and observe metrics related to performance of various services and applications of the enterprise for enhanced business outcomes. Techniques are provided for a dashboard generation system that receives authentication credentials to extract the profile of the user. The profile of the user may include the credentials of the user including unique customer identification, the enterprise identification and the role of the user in the enterprise. One or more widgets are identified for presentation on the dashboard layout based on the profile of the user. The data associated with the widgets may be retrieved, wherein the data may include user preferences, information on historical interactions with the widgets and a score associated with the widgets. The score may be allocated to the widgets based on the usefulness of the widgets in solving a problem associated with the business process. One or more widgets are selected for displaying on the dashboard layout based on a combination of factors including user profile and the score associated with the widgets. The dashboard layout is then dynamically rendered to the user with only the widgets that are selected based on the combination of user profile and score associated with the widgets.

In one embodiment, the present disclosure provides a method for rendering a dashboard layout to a user in a business enterprise. The method comprises receiving authentication credentials from the user. The method comprises retrieving a profile of the user based on the authentication credentials, wherein the profile includes at least one of a user identifier, an identifier of the business enterprise, a role of the user in the business enterprise. The method further comprises identifying one or more widgets based on the profile of the user. The method further comprises retrieving data associated with the one or more widgets, wherein the data for each of the one or more widgets comprises at least one of a user preference rating, information on historical interactions, a score based on historical data. The method further comprises selecting the one or more widgets based on a combination of the profile of the user and the data associated with the one or more widgets and dynamically rendering the dashboard layout with the selected widgets.

In another embodiment, the present disclosure provides a system for rendering a dashboard layout to a user in a business enterprise, the system comprising, a processor and a memory storing program instructions which, when executed by the processor, causes the processor to receive authentication credentials from the user. The processor is further configured to retrieve a profile of the user based on the authentication credentials, wherein the profile includes at least one of a user identifier, an identifier of the business enterprise, a role of the user in the business enterprise. The processor is further configured to identify one or more widgets based on the profile of the user. The processor is further configured to retrieve data associated with the one or more widgets, wherein the data for each of the one or more widgets comprises at least one of a user preference rating, information on historical interactions, a score based on historical data. The processor is further configured to select the one or more widgets based on a combination of the profile of the user and the data associated with the one or more widgets and dynamically render the dashboard layout with the selected widgets.

In yet another embodiment, the present disclosure provides a non-transitory computer-readable storage medium, storing program instructions executed by a processor to render a dashboard layout to a user in a business enterprise. The program instructions when executed by the processor, receives authentication credentials from the user. The program instructions when executed by the processor, retrieves a profile of the user based on the authentication credentials, wherein the profile includes at least one of a user identifier, an identifier of the business enterprise, a role of the user in the business enterprise. The program instructions when executed by the processor, retrieves data associated with the one or more widgets, wherein the data for each of the one or more widgets comprises at least one of a user preference rating, information on historical interactions, a score based on historical data. The program instructions executed by the processor selects the one or more widgets based on a combination of the profile of the user and the data associated with the one or more widgets and dynamically renders the dashboard layout with the selected widgets.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an exemplary block diagram of an environment in which embodiments of the present disclosure may operate;

FIG. 2 illustrates an exemplary block diagram of a system for rendering a dashboard layout to a user in a business enterprise, in accordance with one or more embodiments described herein;

FIG. 3 illustrates another exemplary block diagram of a system (depicted in FIG. 2) for rendering a dashboard layout to a user in a business enterprise, in accordance with one or more embodiments described herein;

FIG. 4 illustrates an exemplary diagram of a dashboard layout, in accordance with one or more embodiments described herein;

FIG. 5 illustrates another exemplary diagram of a dashboard layout rendered dynamically, in accordance with one or more embodiments described herein;

FIG. 6 illustrates a flow diagram of a method for rendering a dashboard layout to a user in a business enterprise, in accordance with one or more embodiments described herein;

FIG. 7 illustrates a general block diagram of a computing system, in accordance with one or more embodiments described herein.

### DETAILED DESCRIPTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

Typically, business enterprises or business entities implement various business processes for managing data and information for the particular enterprise. A series of tasks or business processes may be performed by the organization or enterprise to achieve a business goal or outcome. The various internal processes can include designing, monitoring and controlling product design processes, production processes, manufacturing processes, sales processes and the like. An enterprise may have thousands of users (customers, partners, clients, employees) who may perform various tasks related to business operations.

Enterprises may be involved in manufacturing, production and distribution of one or more products and the products may include but not limited to healthcare related products including medical devices, medicines, therapeutic compositions. For example, the enterprises may be involved in various processes including annual product quality review, quality management review, recalling of faulty products, quality control issues, supply chain problems, regulatory compliance, knowledge management review, design control etc. Other examples may include but not limited to audit planning, emergency response systems, among others.

The complexity of data and metrics that is handled and monitored may vary based on the type of industry, size of the enterprise, and/or products or services that the industry caters to. Moreover, when enterprises handle large amounts of data that is captured in real-time, it may further increase the operational complexity. Typically, observability dashboards are used by business enterprises to monitor the health of the enterprise and improve business outcomes. Dashboards act as an effective digital interface for collecting, displaying, monitoring and analyzing data in real-time for different enterprise applications. They help in highlighting trends and recording anomalies or deviations. Document management solutions in business enterprises, for example, may use dashboards that capture errors in production, errors in allocation of memory resources, code exception errors, etc. These errors may be captured in multiple dashboards like a memory tracker dashboard, CPU metrics dashboard, code exception dashboard, etc.

As businesses grow, large amount of real-time data is manipulated and analyzed for different enterprise applications. This leads to a scenario where multiplicity of dashboards has to be accessed making it complex and cumbersome for users to understand which dashboard to refer to fix problems and debug errors. Therefore, every customer or user who uses the enterprise application may need to have access to only a subset of dashboards for a given task. A customized dashboard layout based on the user's specific requirements may be needed so that the user does not waste time and resources navigating through multiple static dashboards to debug errors and issues.

Accordingly, there is a need to provide an efficient system and framework for dynamic rendition of dashboard layouts to users that is flexible and is adaptable to evolving business requirements, making it easy for the users to navigate through the internal business processes within an enterprise.

There is also a need to provide an efficient system for managing dashboard generation in dynamic work environments of business enterprises to enable reliability and accuracy of data, quick resolution of errors, and to improve the operational efficiency of the enterprises.

Accordingly, the present disclosure provides document management systems for business enterprises or organizations. Particularly, the present disclosure relates to a method and system for providing a dashboard generation system that enables dynamic rendition of dashboard layout to users.

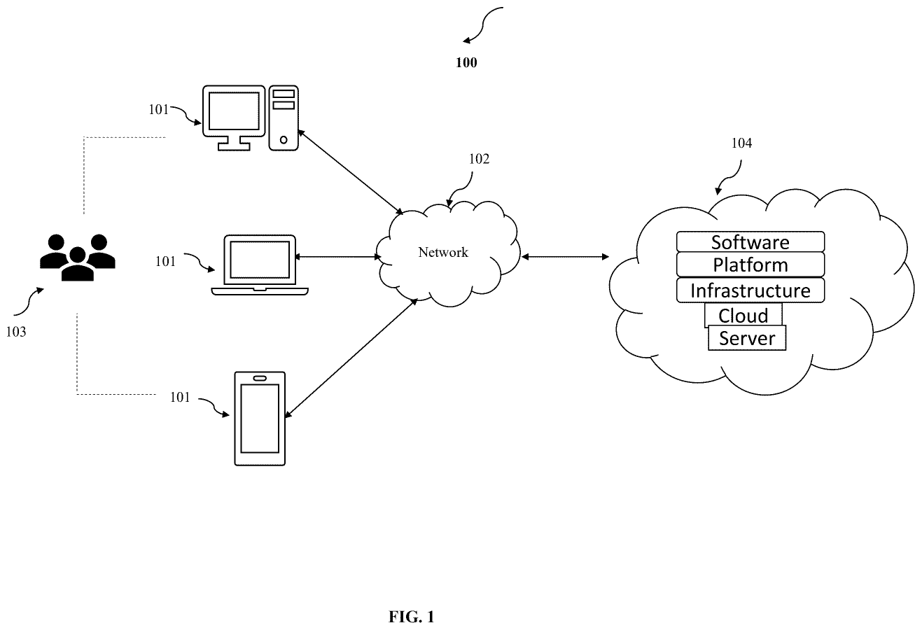

FIG. 1 illustrates an exemplary block diagram of an environment 100, in which the embodiments of the present disclosure may operate. Specifically, FIG. 1 illustrates a plurality of client devices 101. In an embodiment, the plurality of client devices 101 may be in operative communication with a cloud environment 104 over a network 102. In one or more embodiments, the one or more client devices 101 is integrated within or corresponds to a mobile computing device, a smartphone, a tablet computer, a mobile computer, a desktop computer, a laptop computer, a workstation computer, a wearable device, a virtual reality device, an augmented reality device, or another type of remote computing device. Although exemplary system 100 is shown with three client devices 101, any number of client devices may be supported.

In an embodiment, the plurality of client devices 101 may be operable by one or more users or clients 103 of a business enterprise or business entity to monitor and manage the operations associated with the operations of the enterprise. In a non-limiting example, enterprises may be involved in the manufacturing, distribution, sale of one or more products, and the products may include but not limited to healthcare related products, including medical devices, medicines, therapeutic compositions, etc. In some embodiments, the users 103 may collect and analyze the information related to performance of the business processes to assess the health of the business environment and resolve data issues. The users 103 may gauge various metrics from different data sources which may aid in business decisions and insights.

According to various embodiments, a network 102 may be configured to provide communication between various components depicted in FIG. 1. In some embodiments, the network 102 may include a public network (e.g., the Internet), (e.g., an internal localized, or closed-off network between particular devices). In some other embodiments, the network 102 may be a hybrid network (e.g., a network enabling internal communications between particular connected devices and external communications with other devices). Such configuration(s) include, without limitation, a wired or wireless Personal Area Network (PAN), a Cloud network, Local Area Network (LAN), Metropolitan Area Network (MAN), Wide Arca Network (WAN), and/or the like. In various embodiments, the network 102 may include one or more base station(s), relay(s), router(s), switch(es), routing station(s), and/or the like.

According to various embodiments, the cloud environment 104 may include one or more servers and may provide different types of cloud computing services including but not limited to one or more services provided under Software as a Service (SaaS) category, services provided under Platform as a Service (Pass) category, services provided under Infrastructure as a Service (IaaS), category. In some embodiments, the cloud environment 104 may also include server-less computing. In some embodiments, the cloud infrastructure is operated solely for an organization called the private cloud. In some embodiments, the cloud infrastructure is shared by several organizations called the community cloud. In some other embodiments, the cloud infrastructure is made available to the general public or a large industry group and is owned by an organization selling cloud services, called the public cloud. In some embodiments, the cloud infrastructure is a composition of two or more clouds (private, community, or public) that remain unique entities but are bound together by standardized or proprietary technology that enables data and application portability.

Embodiments of the present disclosure may provide dynamic rendition of dashboards for a multi-tenant cloud-based system. Embodiments of the present disclosure may manage and monitor metrics, applications, services and data both in the cloud and on-premise. Embodiments of the present disclosure may support multi-channel access via web, mobile, and application programming interfaces (“APIs”). Embodiments of the present disclosure may manage access for different users, such as customers, partners, and employees. Embodiments of the present disclosure may integrate with third-party applications, new and existing applications and identities. Embodiments of the present disclosure may be scalable.

Embodiments of the present disclosure may be based on a multi-tenant, microservices architecture for managing cloud-scale software services. Multi-tenancy refers to having one physical implementation of a service securely supporting multiple customers buying that service. A service is a software functionality or a set of software functionalities that can be reused by different clients for different purposes.

In an embodiment, the plurality of client devices 101 may be utilized by one or more clients or users 103 to connect to the cloud environment 104 via a secure communication channel over the network 102. In an embodiment, the users 103 may provide authentication credentials through the one or more client devices 101. In some embodiments, the authentication credentials may include a username, password, and the like. Once the user is authenticated, the one or more users of the enterprise may track and manage the dynamic work environments of the enterprise.

In an embodiment, the users 103 operating one or more client devices 101 may use interactive user interface dashboards to collect and monitor metrics related to the performance of the system. In some embodiments, the users 103 may utilize intelligent and customized observability dashboards to collect, monitor and gain visibility on various metrics related to infrastructure, servers, networks, applications, services, databases, logs, traces, thereby maintaining overall system health and enhancing customer experience.

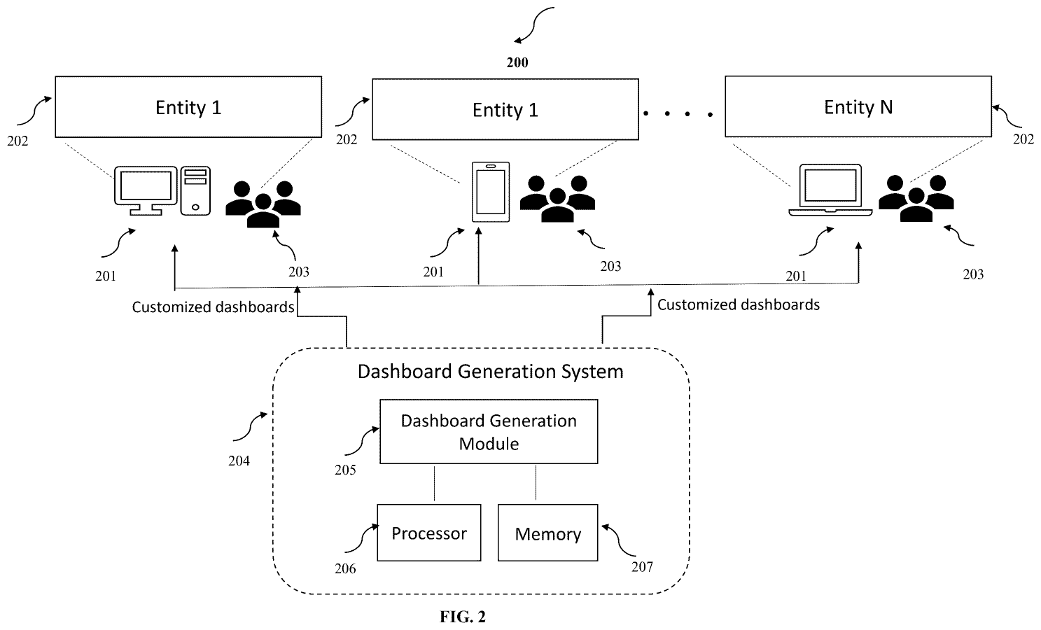

FIG. 2 is an exemplary block diagram illustrating a system 200 for rendering a dashboard layout to a user in a business enterprise in accordance with one or more embodiments described herein. In an embodiment, the system 200 may comprise a plurality of users 203 operating one or more client devices 201 (101, FIG. 1) from a plurality of business entities 202. In some embodiments, one or more business entities 202 may be involved in manufacturing, production, distribution, sales of one or products, and the products may include but not limited to healthcare related products, including medical devices, medicines, therapeutic compositions, etc. In an embodiment, the users 203 may be employees, clients, customers, partners who run software applications and execute workflows associated with operations of the business entity. For example, workflows or applications in a manufacturing unit of an enterprise may include but not limited to annual product quality review, quality management review, recalling of faulty products, quality control issues, supply chain problems, regulatory compliance, knowledge management review, design control etc. Other examples may include but not limited to intelligent audit planning, emergency response systems, among others. While examples described are herein with reference to healthcare domain, the example system 200 may be used in a plurality of domains and not limited to any specific application as disclosed herein. The plurality of domains may include education, industrial, manufacturing, among others.

In an embodiment, the client devices 201 may run the software applications or services that are provided via the server or cloud environment 104 (FIG. 1). The applications and services can be developed as a single service like a monolithic application or as a collection of small services, such as microservices. In microservices-based applications, each microservice runs independently of other services of the enterprise application to achieve a business outcome. The microservices based cloud applications typically may have to handle large amounts of dynamic data which may result in increased operational complexity. Therefore, in order to monitor and manage the dynamic nature of data, the users may have to use multiple dashboards for detecting any problem scenarios, failures, errors or issues that may arise in operations of the enterprise.

Typically, in observability dashboards for a multi-tenant solution, data visualizations are created to cater to different end users, teams and departments of the enterprise. For example, data visualizations may be created for product team, sales and marketing team, engineering team, development and operations (DevOps) team, infrastructure team, human resources team, among others as per their specific requirements. The end users 203 of the enterprise who have different roles in the enterprise like for example, SaasOps architecture, product management, application development may track and observe the data visualizations on the dashboard. For example, the end users 203 may include system administrators, architects, SaasOps engineers, application developers, product managers, etc. The users 203 may monitor and observe data and metrics related to different data sources corresponding to the user role to support business decisions at all levels in an enterprise.

To this end, the business entities typically employ a variety of dashboards having data visualizations in the form of graphs, pie charts, histograms, tables, datagrid, etc. to support observability. Examples of dashboards may include but not limited to sales and marketing dashboards, operational dashboards, analytical dashboards, customer dashboards, business intelligence (BI) dashboards, KPI dashboards, executive dashboards, etc. Various metrics related to business operations may be monitored including sales figures, employee performance, status of business projects, IT operations including the utilization of networks, servers, databases, applications, services, security issues, cost and performance issues. The operational dashboards for example may track the status of business operations showing metrics on manufacturing and production issues and whether the production goals are achieved. For example, dashboards may be used for presenting data about aspects of a network such as CPU and memory utilization. Example dashboards may include one or more histograms to facilitate data visualization and performance optimization. In some examples, checks are made on operational metrics as to whether containers (executable units of software) are up and running, the number of jobs that failed, processing that failed, the files that were downloaded, requests that were received, CPU utilization, memory usage, load on the system, disk space usage, databases, logs, traces, events, resource allocations, etc. The human resource dashboards may include information on workforce data like employee data and key performance indicators (KPI) statistics related to costs, skillset, etc. When such large amount of data needs to be tracked, different teams across the enterprise require a myriad of data visualizations which results in multicity of dashboards being created, thereby increasing the complexity of dashboard interface.

When large number of dashboards are created, the interface becomes cluttered with the users needing to navigate between all the dashboards to determine any issues or errors or failures that might have occurred in business operations. Currently, the dashboards are static making it cumbersome for the users 203 to observe and analyze the problems that occur in the business operations. For example, sometimes the failures may occur due to third-party services throwing internal exception while converting a docx file into pdf file, this error may not be necessarily reflected in the CPU metrics dashboard. Similarly, sometimes an error may occur due to memory leak, which is observed in the Memory tracker dashboard but not necessarily in the code exceptions dashboard. The end users 203 may thus come across various operational issues, latency issues, production issues, misallocation of resources, under-utilization of resources, reaching threshold limits for certain services, code exception errors, third party services being down, the cloud service going through an upgrade, etc. compromising the performance of the system.

Therefore, there is a need to customize and re-arrange the dashboard and generate a focused observability dashboard layout so that the end users 203 are able to navigate through the dashboards seamlessly and quickly fix critical issues and errors discussed supra. The dashboards may be dynamically generated based on specific user requirements so that data visualizations provide quick and actionable insights helping the end users make informed business decisions.

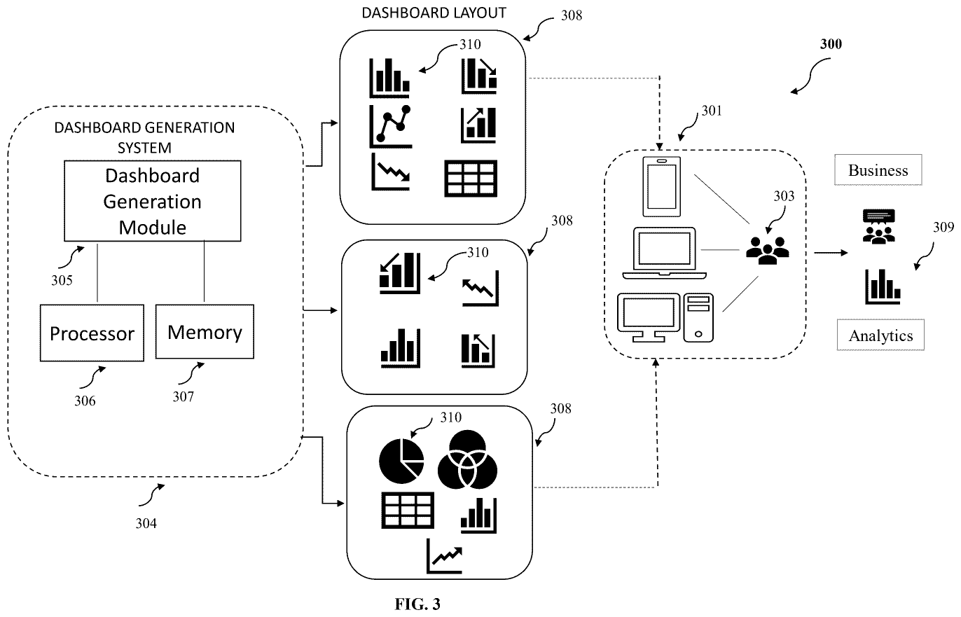

To this end, according to an embodiment, the system 200 comprises a dashboard generation system 204 for dynamically rendering a dashboard layout to a user 203. In some embodiments, the dashboard generation system 204 may comprise a dashboard generation module 205. The dashboard generation module 205 may enable a dynamic rendition of dashboard layout to the end user 203 who logs into the client device 201. The dashboard generation module 205 generates customizable dashboards tailored to the needs of each individual user 203 and the role of the user in the enterprise. For example, a product manager and a DevOps manager may track dashboards for information but the kind of metrics needed for each user may vary depending upon the user role, their preferences, historical interactions, the usefulness of the data visualizations in resolving an issue. Similarly, the sales team, manufacturing and human resources team may track different metrics according to their department. In an embodiment, the dashboard generation module 205 may dynamically customize and adapt the data visualizations on the dashboard layout to detect and respond to issues more effectively. The functions of the dashboard generation module 205 is explained in greater detail in FIG. 3.

In some embodiments, the dashboard generation system 204 also comprises a processor 206 communicably coupled to a memory 207. The processor 206 may store and execute instructions for implementing the functions of the dashboard generation system 204. In an embodiment, the dashboard generation system may include a memory 207 operatively to the processor 206. The memory 207 may be non-transitory and may include, for example, one or more volatile and/or non-volatile memories. In some embodiments, the memory 207 includes or embodies an electronic storage device (e.g., a computer readable storage medium). In some embodiments, the memory 207 is configured to store information, data, content, applications, instructions, or the like, for enabling a system to carry out various operations and/or functions in accordance with example embodiments of the present disclosure.

In one or more embodiments, the system 200 may include one or more software modules or components for managing dashboard generation in dynamic work environments in accordance with the one or more embodiments of the present disclosure. In an embodiment, the one or more software modules may include but not limited to the dashboard generation module 205 which implements the functions of the dashboard generation system 204 through the processor 206.

In one preferred embodiment, the system 200 of the present disclosure may be configured as a cloud-based system. In various embodiments, the cloud environment 104 may be configured to run one or more services or software applications provided by one or more components of the system 200. In some embodiments, the services may be offered as web-based or cloud-based services to the users 203 of the client devices 201. In another embodiment, one or more of the components of system 200 and/or the services provided by the components may also be implemented by one or more client devices 201. Users operating the client devices 201 may utilize one or more client applications to use the services provided by the components of the system 200.

In an embodiment, one or more modules of the system 200 may be implemented using electronic hardware, computer software, or any combination thereof. Whether such elements are implemented as hardware or software depends upon the application and design constraints imposed on the overall system. Examples of the systems may include computing systems (e.g., servers, datacenters, desktop computers, Internet of Things devices, etc.) and mobile computing systems (e.g., laptops, cell phones, etc.). Although components are described with respect to functional limitations, it should be understood that the particular implementations necessarily include the use of particular computing hardware. It should also be understood that in some embodiments certain of the components described herein include similar or common hardware.

The functions of the dashboard generation module 205 and the dashboard generation system 204 of FIG. 2 are described in greater detail in FIG. 3.

FIG. 3 illustrates another exemplary block diagram of a system 300 for rendering a dashboard layout to a user in a business enterprise in accordance with one or more embodiments described herein. In an embodiment, the system 300 may be configured to manage dashboard rendition in dynamic work environments of business enterprises with an aim to provide optimum performance of the system. The system 300 may include a dashboard generation system 304 comprising a dashboard generation module 305. The dashboard generation system 304 may comprise a processor 306 coupled to a memory 307. In an embodiment, the dashboard generation system 304 may enable effective and dynamic generation of a dashboard layout 308 to users 303 operating one or more client devices 301.

In an embodiment, the dashboard layout 308 may contain various forms of data visualizations depicting different performance metrics, statistics, and information related to business operations. In some non-limiting examples, the data visualizations may include but not limited to graphs, line and bar charts, tables, widgets, icons, filters, images, tabs, drop-down menus, text boxes, and navigation features among others. In an embodiment, the dashboard generation system 304 may be integrated with third-party services for rendering real-time data on the functioning of the services.

In an embodiment, a user or customer of a business enterprise may login through one or more client devices 201 (FIG. 2) to track and manage the operations of the business enterprise. In an embodiment, the dashboard generation module 305 may receive authentication credentials from the user through one or more client devices 201 (FIG. 2). In some embodiments, the authentication credentials may include a username, password, and the like. In an embodiment, the dashboard generation module 305 may retrieve the profile of the user based on the authentication credentials. According to an embodiment, the profile of the user may be stored in in a database. In some embodiments, the database may be a local database. In some embodiments, the database may be a cloud-based database.

According to an embodiment, the profile of the user may include a unique identifier of the organization or business enterprise that the user is associated with. In an embodiment, the profile of the user may also include an identifier of the user, which may be unique credentials identifying the user. In an embodiment, the profile of the user may include a role of the user in the enterprise. For example, the users in an enterprise may be from different departments like sales team, manufacturing team, infrastructure team, product team, etc. who may perform different functions for managing the business operations. The users 303 may have different roles or designations in an organization like administrator, product manager, DevOps manager, SaasOps manager, architect among others who manage the data and operations pertinent to their roles.

In an embodiment, the dashboard generation module 305 may identify one or more widgets 310 for displaying on the dashboard layout 308 based on the profile of the user 303. In an embodiment, the widgets 310 are data visualizations depicting the metrics and statistics related to the performance of various servers, networks, databases, applications, services, logs, events, traces, third-party services. In an embodiment, the widgets 310 allow the user to take any action while interacting with the dashboard. In an embodiment, the widgets 310 on the dashboard layout 308 are identified based on the profile of the user. In an embodiment, the profile of the user may include unique identifier of the customer, the unique identifier of the organization and the role of the user played by the user in the enterprise or organization. For example, a user 303 may have a unique organization identification and a unique customer identification based on which the user is authenticated for navigating through the different visualizations on the dashboard. In an embodiment, the system 300 provides a multi-tenant solution catering to various tenants (business entities) and its users. The organization ID and the customer ID includes credentials identifying the organization and the user.

In an embodiment, the widgets 310 are identified based on the role of the user in the organization or enterprise. For example, the roles may be based on designation of the user in the enterprise ranging from product manager, architect, DevOps manager, SaasOps manager, administrator, among others who perform different functionalities with the widgets 310 suited to their role or designation. In an embodiment, the attributes of the user profile allow the dashboard generation system 304 to identify the one or more widgets 310 for the dashboard layout with which the user can interact to debug errors, gain visibility, track metrics, make informed business decisions.

In an embodiment, based on the profile of the user 303, the dashboard generation module 304 may retrieve data associated with the one or more identified widgets 310. In an embodiment, the data that is retrieved may be associated with the one or more widgets 310 and may include metadata regarding a preference rating of the user, information on historical interactions and a score of the widget based on historical data. In an embodiment, the preference rating of the user 303 may include metadata regarding the user's preference for one widget 310 over the other widget 310 while performing an action on the dashboard. For example, if the user from infrastructure team is looking to debug an error like a memory leak error, a particular widget 310 may be of preference to the user based on the context, relevance, usefulness of the widget 310 in debugging the error.

In an embodiment, the data retrieved by the dashboard generation module 305 may be associated with the widget 310 and, may include information on historical interactions with the widget 310 by the user. For example, the user may have interacted with one or more widgets 310 a number of times in the past in resolving a production issue, i.e. a frequent use of a particular widget 310 may be used to infer the need of the user. In an embodiment, the information on historical interactions may include metadata regarding observed past user interaction patterns with one or more widgets 310 in the context of the user role and the organization that the user is associated with. For example, when debugging a code exception error, the user may have interacted with a particular widget 310 in the past which might have provided a quick resolution to the problem scenario.

In another embodiment, the data retrieved by the dashboard generation module 305 may be associated with one or more widgets 310 and, may include a score associated with one or more widgets 310. In an embodiment, the score allocated to the widgets 310 may be a rating given to the widgets 310 by the user based on a variety of metrics including usefulness of the widgets 310 in resolving an operational issue. In an embodiment, the scoring may be based on the relevance and performance of the widgets 310 in troubleshooting an error condition. In another embodiment, the score may be rating given to the widget 310 based on metrics like actionability and timeframe in resolving the issue. For example, when a user is attempting to debug a code exception error, a particular widget 310 may have a better performance level in solving the issue over another widget. In another example, the scoring may be based on the time spent by a user to debug the error while going through the service logs. In another example, the scoring may be based on how useful the widgets 310 were in resolving the issue that occurred in real-time. In yet another example, the scoring may also be based on the kind of actionable insights the widgets 310 provide to the user to aid business intelligence. In an embodiment, the widgets 310 that are presented on the dashboard layout 308 are based on the recommended score associated with the one or more widgets 310.

According to an embodiment, the scores given by the user to the one or more widgets 310 are historically saved in data repository or database. In an embodiment, the database may be a local database. In another embodiment, the database may be a cloud-based database. An example table of scores for widgets 310 based on the user roles is given below. As can be seen from the table, the scores are given to different widgets based on the role of the user in the organization ranging from architect, DevOps engineer, SaasOps engineer, product manager, App Developer, etc. Some examples of widgets 310 include data regarding total rendition requests, metrics for CPU usage, exceptions and failures by third-party services like Adlib, Aspose etc.

| StakeHolder | WidgetId | Score |
|---|---|---|
| Architect | Total Failure Renditions | 8 |
| Product Manager | Total success per region | 8 |
| Architect | Rendition Broker Requests | 7 |
| App Developer | Rendition Staging Count | 7 |
| SaasOps Engineer | Metrics for CPU | 9 |
| SaasOps Engineer | Metrics for Pods | 3 |
| Architect | Adlib Restarts | 4 |
| App Developer | Internal Adlib Exceptions | 6 |
| SaasOps Engineer | Adlib Failures | 6 |
| Product Manager | Support cases resolution time | 7 |

In one implementation, the scores of certain widgets 310 may be high as they are given a good recommendation by the user in solving an issue or problem scenario. In another implementation, the scores of the widgets 310 may be low due to the user not recommending the widgets for taking any action. In an embodiment, the score allocated to the widget 310 determines the position of the widgets 310 on the dashboard layout 308. For example, the widget with high score may be displayed or arranged prominently at the top of the dashboard layout 308 compared to widgets 310 with low score displayed at the bottom of the dashboard layout 308. Therefore, the score of the one or more widgets 310 determines the arrangement and positioning of the widgets on the dashboard layout 308.

In an embodiment, the dashboard generation module 305 may select the one or more widgets based on a combination of the profile of the user and the data associated with the one or more widgets 310. The widgets 310 are selected considering a combination of factors including the unique customer identification, the organization identification, the role of the user in the organization, and the score of the widget 310. The dashboard generation module 305 thus selects only a subset of widgets 310 for presentation on the dashboard layout 308 based on the combination of factors including profile of the user and score of the widgets 310 in order to present a concise overview and suit user needs.

In an embodiment, the dashboard generation module 305 may dynamically render the dashboard layout with the selected widgets 310. The dashboard generation module 305 may enable dynamic rendition of the dashboard layout 308 by displaying only the widgets 310 selected based on a combination of the profile of the user and the data associated with the widgets. Upon login through the client device 301 by the user 303, the dashboard layout 308 that is rendered which is customized considering a combination of factors including the unique customer identification, the organization identification, the role of the user in the organization, and the score of the widget 310. Thus, the dynamic rendition of the dashboard layout 308 with only the selected widgets 310 enables a more focused visibility into the operations of the enterprise thereby enabling quick debugging of errors and issues. In an embodiment, the dashboard layout 308 that is rendered dynamically helps in enhancing observability on real-time data and historical data which in turn helps in providing actionable business insights and analytics 309, identifying trends and patterns and forecasting future issues.

According to an embodiment, the score of the widgets 310 may be updated by the user by giving a rating based on a current action of the user on the rendered dashboard layout 308. For example, if a particular widget 310 was useful in debugging an error quickly, the user may rate the widget 310 by pressing a thumbs up icon. The updated score of the widgets 310 may be stored in the database for future rendition. In an embodiment, the score of the widgets 310 may be updated by different users based on the usefulness of the widget 310. In an embodiment, the system 300 may dynamically render the dashboard layout 308 based on updated scores of the widgets 310, wherein the updated scores will determine the layout of the widgets 310. In an embodiment, the score allocated to widgets 310 is based on its usefulness in debugging an error associated with one or more services, wherein the error includes at least one of a memory leak error, a code exception error, etc. In an embodiment, the dashboard user interface (UI) is rendered with the dashboard layout 308.

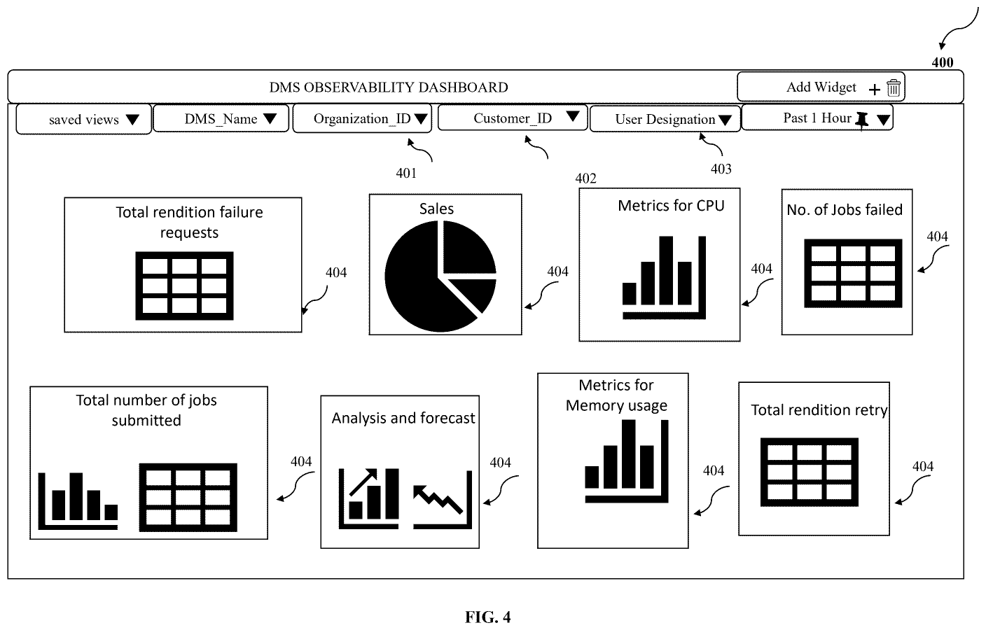

FIG. 4 illustrates an exemplary diagram of a dashboard layout, in accordance with one or more embodiments described herein. In an embodiment, a user 203 (FIG. 2) may login to the document management system (DMS) through one or more client devices 201 to monitor and observe various metrics related to business operations. The dashboard layout 400 may be displayed to the user which may have drop down list 401, 402, 403 for retrieving profile attributes of the user. The dashboard layout 400 may display a plurality of interactive widgets 404 presenting metrics that include but not limited to CPU usage, memory usage, disk space usage, number of rendition requests, number of jobs submitted for processing, sales figures, number of retries for rendition, business analysis and forecast, among others. In an embodiment, the widgets 404 displayed to the user help in analyzing the metrics which in turn aids in debugging of errors, resolving issues and gaining business insights.

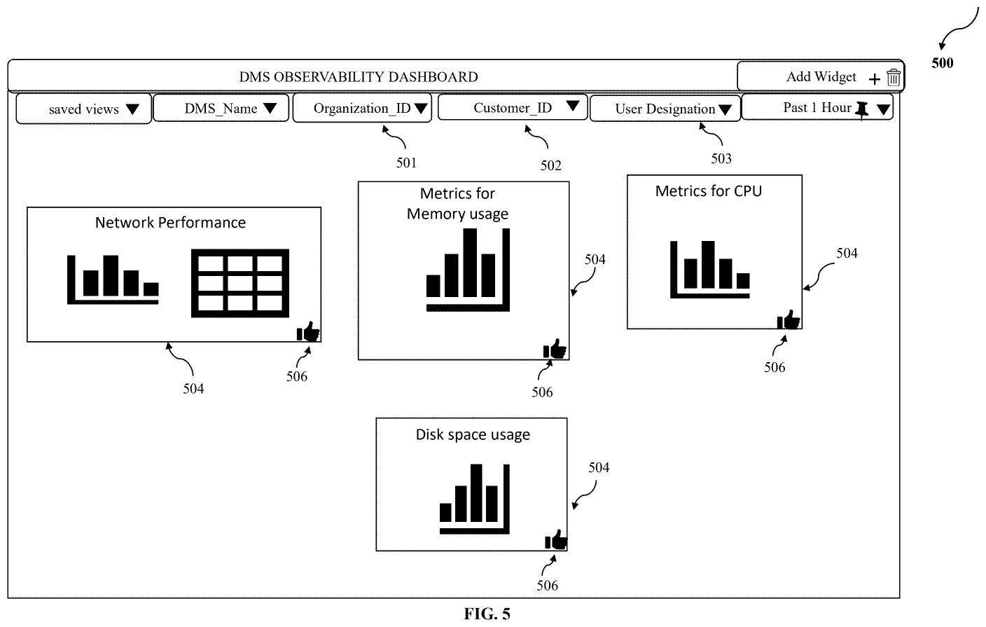

FIG. 5 illustrates an exemplary diagram of a dashboard layout rendered dynamically, in accordance with one or more embodiments described herein. In an embodiment, a user 203 (FIG. 2) may login to the document management system (DMS) through one or more client devices 201 to monitor and observe various metrics related to business operations. The dashboard layout 500 may be displayed to the user which may have drop down list 401, 402, 403 for retrieving profile attributes of the user. In an embodiment, the profile of the user may comprise unique identification details of the user, the organization, the user is associated with, and the role of the user played by the user in the organization. In an example embodiment, if a user from an infrastructure team logs into the DMS using the dropdown list 501, 502, 503, based on the profile of the user and the retrieved data associated with the widgets 504, the dashboard layout 500 may dynamically display only selected widgets or a subset of widgets 504 relevant to the infrastructure team. The data associated with the widgets 504 as discussed supra, may include the user's preferences, past historical interactions and scores associated with the widgets 504. The different metrics, for example may include CPU usage, memory usage, disk space usage, network performance, which may be of relevance to the infrastructure team thus giving a decluttered and organized dashboard layout to the user and enhancing customer experience. This dynamic rendition of the dashboard layout 500 enables the user to quickly navigate through the widgets 504 that are of relevance thereby aiding easy debugging of errors and issues, and saving time and resources.

According to an embodiment, the user may be able to update the score on the widget 504. For example, if one or more widgets 504 were useful in debugging an error quickly, the user may rate the widget 504 by pressing a thumbs up icon 506. The updated score of the widgets 504 may be stored in the database for future rendition. In an embodiment, the score of the widgets 504 may be updated by different users based on the usefulness, relevance, actionability, etc. of the widget 504. In an embodiment, the system 300 may dynamically render the dashboard layout 500 based on updated scores of the widgets 504, wherein the updated scores will determine the arrangement of the widgets 504 on the dashboard layout 504.

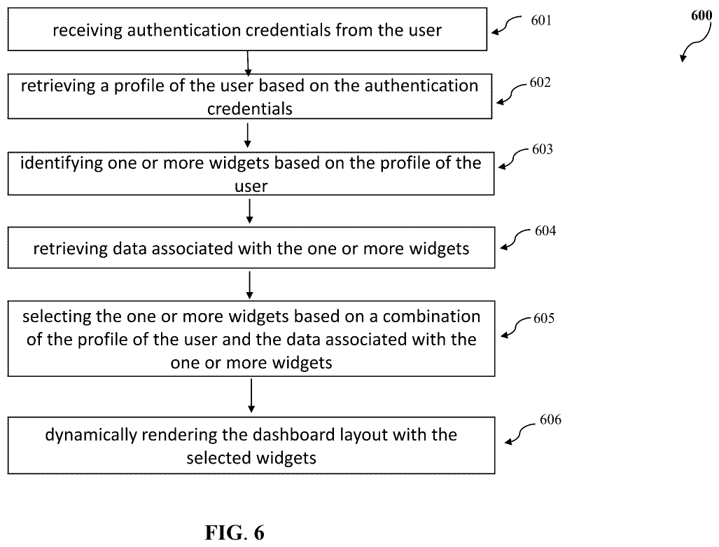

FIG. 6 illustrates an exemplary method for rendering a dashboard layout to a user of a business enterprise in accordance with one or more embodiments described herein. The method, 600 may be implemented by the system as described above in FIGS. 2,3. The method 600 is illustrated as logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. The order in which the operations are described is not intended to be construed as a limitation, and any number of the described operations can be combined in any order and/or in parallel to implement the method.

According to an embodiment, the method 600 may be implemented by one or more processors or modules illustrated and explained through FIGS. 2-3, therefore detailed explanation of the same is omitted here for the sake of brevity.

The method begins at step 601, wherein the method 600 includes receiving authentication credentials from the user of the business enterprise 202 (FIG. 2). In an embodiment, the authentication credentials may be username, password and the like. In an embodiment, the operations at step 601 may be performed by the dashboard generation system 204, 304 of FIGS. 2, 3. The plurality of client devices 201 may be operable by users 203 of a business entity or organization 202 to manage dynamic work environments and its associated business operations typically to achieve a particular business goal or objective. For example, an enterprise may have thousands of users (partners, clients, employees) who may perform various workflows related to business operations. For example, the workflow applications in a manufacturing unit of an enterprise, for example may include but not limited to annual product quality review, quality management review, recalling of faulty products, quality control issues, supply chain problems, regulatory compliance, knowledge management review, design control etc. In an embodiment, the users 203 may observe and track metrics and data associated with operations of the business enterprise with the help of monitoring dashboards to debug errors and gain business insights.

At 602, the method 600 includes retrieving a profile of the user based on the authentication credentials, wherein the profile includes at least one of a user identifier, an identifier of the business enterprise, a role of the user in the business enterprise. In an embodiment, the operations at step 602 may be performed by the dashboard generation system 204, 304 of FIGS. 2, 3. For instance, the profile of the user may include a unique identifier of the user, a unique identifier of the organization or tenant, role of the user in the enterprise. According to an embodiment, the profile of the user may include a unique identifier of the organization or business enterprise that the user is associated with. In an embodiment, the profile of the user may also include an identifier of the user, which may be unique credentials identifying the user. In an embodiment, the profile of the user may include a role of the user in the enterprise. For example, the users in an enterprise may be from different departments like sales team, manufacturing team, infrastructure team, product team, etc. who may perform different functions for managing the business operations. The users may have different roles or designations in an organization like administrator, product manager, DevOps manager, SaasOps manager, architect among others who manage the data and operations pertinent to their roles.

At 603, the method 600 includes identifying one or more widgets based on the profile of the user. In an embodiment, the operations at step 603 may be performed by the dashboard generation system 204, 304 of FIGS. 2,3. In an embodiment, the widgets 310 (FIG. 3) are data visualizations depicting the metrics and statistics related to the performance of various servers, networks, databases, applications, services, logs, events, traces, third-party services. In an embodiment, the widgets allow the user to take any action while interacting with the dashboard. In an embodiment, the widgets 310 on the dashboard layout 308 are identified based on the profile of the user. In an embodiment, the attributes of the user profile allow the dashboard generation system 304 to identify the one or more widgets 310 for the dashboard layout with which the user can interact to debug errors, gain visibility, track metrics and make informed business decisions.

At 604, the method 600 includes retrieving data associated with the one or more widgets, wherein the data for each of the one or more widgets comprises at least one of a user preference rating, information on historical interactions, a score based on historical data. In an embodiment, the operations at step 604 may be performed by the dashboard generation system 204, 304. In an embodiment, the preference rating of the user may include metadata regarding the user's preference for one widget over the other widget while performing an action on the dashboard. In an embodiment, the information on historical interactions may include metadata regarding observed past user interaction patterns with one or more widgets in the context of the user role and the organization, that the user is associated with. In an embodiment, the score allocated to the widgets may be a rating given to the widgets by the user based on a variety of factors including usefulness of the widgets in resolving an operational issue. In an embodiment, the scoring may be based on the relevance and performance of the widgets in troubleshooting an error condition. In another embodiment, the score may be rating given to the widget based on metrics like actionability and timeframe in resolving the issue.

At step 605, the method 600 includes selecting the one or more widgets based on a combination of the profile of the user and the data associated with the one or more widgets. In an embodiment, the operations at step 605 may be performed by the dashboard generation system 204, 304. In an embodiment, only a subset of widgets are selected for presentation on the dashboard layout based on the combination of factors including profile of the user and score of the widgets in order to present a concise overview and suit user needs.

At step 606, the method 600 includes dynamically rendering the dashboard layout with the selected widgets. In an embodiment, the operations at step 606 may be performed by the dashboard generation system 204, 304. In an embodiment, dynamic rendition of the dashboard layout 308 is enabled by displaying only the widgets selected based on a combination of the profile of the user and the data associated with the widgets. In an embodiment, the high scoring widgets are arranged at the top and center of the dashboard layout and the low scoring widgets are arranged at the bottom of the dashboard layout.

In an embodiment, the method 600 comprises the score updating the score of the widgets by giving a rating based on a current action of the user on the rendered dashboard layout. For example, if a particular widget was useful in debugging an error quickly, the user may rate the widget by pressing a thumbs up icon on the widget. The updated score of the widgets 310 may be stored in the database for future rendition. In an embodiment, the method comprises rendering a dashboard user interface (UI) with the dashboard layout.

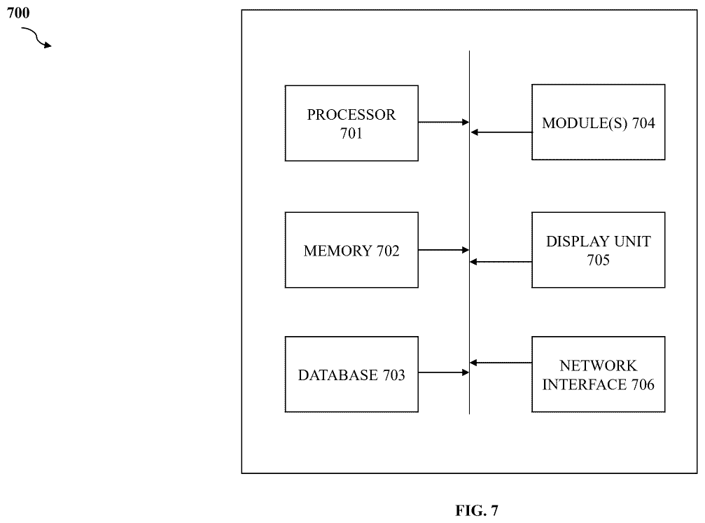

FIG. 7 illustrates a general block diagram of an exemplary computing system 700 used in dashboard generation system according to an embodiment of the present disclosure. The computing system 700 includes a processor 701 which may be a single processing unit or a number of units, all of which could include multiple computing units. The processor 701 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 701 is configured to fetch and execute computer-readable instructions and data stored in a memory 702.

The memory 702 may be any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

In an example, the computing system 700 may include one or more software modules or components 704 for observing and managing dynamic work environments in accordance with the one or more embodiments of the present disclosure. In an embodiment, the one or more software modules 704 may include a program, a subroutine, a portion of a program, a software component or a hardware component capable of performing a stated task or function. As used herein, the modules may be implemented on a hardware component such as a server independently of other modules, or a module can exist with other modules on the same server, or within the same program. The module(s) 704 may be implemented on a hardware component such as processor one or more microprocessors, microcomputers, microcontrollers, digital signal processors, central processing units, state machines, logic circuitries, and/or any devices that manipulate signals based on operational instructions. The module(s) 704 when executed by the processor 701 may be configured to perform any of the described functionalities. Specifically, the module(s) 704 may be configured to implement the dynamic dashboard rendition system enabling focused observability and enhanced customer experience.

The computing system 700 may comprise a database 703 and may be implemented with integrated hardware and software. The hardware may include a hardware disk controller with programmable search capabilities or a software system running on general-purpose hardware. Examples of databases are but not limited to, in-memory databases, cloud databases, distributed databases, embedded databases, and the like. The database amongst other things, serves as a repository for storing data processed, received, and generated by one or more of the processors 701, and the module(s) 704. In an embodiment, the modules 704 may be implemented with an AI module.

The computing system 700 comprises a display unit 705 that includes a computer monitor, a touch screen, an output device capable of displaying the graphics, and the like. The display unit 705 is configured to display visual output in desktops, laptops, and workstations.

The computing system 700 comprises a network interface 706 configured to provide and establish communication with any electronic device via a public network, private network, or any wireless communication technology.

Embodiments of the present disclosure may thus provide an efficient system and method for rendering a dashboard layout to a user in dynamic business environments. The system is aimed to provide optimum performance and is adaptable to evolving business requirements, making it easy for the users to navigate through the internal business processes within an enterprise and quickly and effectively resolve errors, issues and problem scenarios. The disclosed techniques aids in improving the overall health of the system by reducing costs, optimizing resources, reducing time spent on repetitive tasks, thereby providing enhanced system performance.

Embodiments of the present disclosure enable managing the work environments dynamically, resulting in improved operational efficiency of the business processes and system performance. The disclosed system and method provide techniques for providing an efficient framework for observability through dynamic rendition of dashboard layouts helping the enterprises in taking informed business decisions, thereby resulting in enhanced business outcomes.

The disclosed system and method may also leverage the possibility of using Artificial intelligence (AI) models to implement the various functionalities disclosed herein. The AI models may be utilized to observe and track data pipelines in real-time by providing uncluttered dashboard layouts thereby avoiding downtime and ensuring accurate and timely delivery of data.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment). The present disclosure intends to include specific reference to all combinations and sub combinations of physically compatible features, components, apparatuses, and processes described herein. As used herein, the term “or” is used in both the alternative and conjunctive sense, unless otherwise indicated. Use of any such aforementioned terms, or similarly interchangeable terms, should not be taken to limit the spirit and scope of embodiments of the present disclosure. As used in the specification and the appended claims. The singular form of “a,” “an,” and “the” include plural references unless otherwise stated. The terms “includes” and/or “including,” when used in the specification, specify the presence of stated features, elements, and/or components, and/or groups thereof.

In an embodiment, the functional units have been labeled as modules, in order to more particularly emphasize their implementation independence. For example, a module may be implemented as a hardware or a software by various types of processors. A module of executable code may, for instance, comprise one or more physical or logical blocks of computer instructions, which may, for instance, be organized as an object, procedure, or function. Nevertheless, the executables of a module need not be physically located together, but may comprise disparate instructions stored in different locations which, when joined logically together, comprise the module and achieve the stated purpose for the module.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

Processor may be embodied in a number of different ways. In various embodiments, the use of the terms “processor” should be understood to include a single core processor, a multi-core processor, multiple processors and/or one or more remote or “cloud” processor(s). In some example embodiments, processor may include one or more processing devices configured to perform independently. In some embodiments, the processor includes hardware, software, firmware, and/or a combination thereof that performs one or more operations described herein.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments, a storage system or other management entity within the artificial intelligence and machine learning infrastructure may also implement automated training with continuous learning based on new data.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed:

1. A method for rendering a dashboard layout to a user in a business enterprise comprising:
receiving authentication credentials from the user;
retrieving a profile of the user based on the authentication credentials, wherein the profile includes at least one of a user identifier, an identifier of the business enterprise, a role of the user in the business enterprise;
identifying one or more widgets based on the profile of the user;
retrieving data associated with the one or more widgets, wherein the data for each of the one or more widgets comprises at least one of a user preference rating, information on historical interactions, a score based on historical data;
selecting the one or more widgets based on a combination of the profile of the user and the data associated with the one or more widgets;
dynamically rendering the dashboard layout with the selected widgets.

2. The method of claim 1, further comprising updating the score associated with the one more widgets based on a current action of the user on the dashboard layout in real time.

3. The method of claim 1, wherein the score allocated to each of the one or more widgets is based on its usefulness in debugging an error associated with one or more services, wherein the error includes at least one of a memory leak error, a code exception error.

4. The method of claim 1, wherein the score allocated to each of the one or more widgets is based on one or more metrics including at least one of usefulness, relevance, performance, actionability, timeframe.

5. The method of claim 1, wherein the score allocated to the one or more widgets is stored in a database.

6. The method of claim 1, further comprising rendering the dashboard layout with the one or more widgets having a high score at top and center of the dashboard layout and the one or more widgets having a low score at bottom of the dashboard layout.

7. The method of claim 1, further comprising rendering a dashboard user interface (UI) comprising the dashboard layout.

8. The method of claim 1, wherein the profile of the user is stored in a database.

9. A system for rendering a dashboard layout to a user in a business enterprise comprising:
a processor;
a memory storing program instructions which, when executed by the processor, causes the processor to:
receive authentication credentials from the user;
retrieve a profile of the user based on the authentication credentials, wherein the profile includes at least one of a user identifier, an identifier of the business enterprise, a role of the user in the business enterprise;
identify one or more widgets based on the profile of the user;
retrieve data associated with the one or more widgets, wherein the data for each of the one or more widgets comprises at least one of a user preference rating, information on historical interactions, a score based on historical data;
select the one or more widgets based on a combination of the profile of the user and the data associated with the one or more widgets;
dynamically render the dashboard layout with the selected widgets.

10. The system of claim 9, wherein the processor is configured to update the score associated with the one more widgets based on a current action of the user on the dashboard layout in real time.

11. The system of claim 9, wherein the score allocated to each of the one or more widgets is based on its usefulness in debugging an error associated with one or more services, wherein the error includes at least one of a memory leak error, a code exception error.

12. The system of claim 9, wherein the score allocated to each of the one or more widgets is based on one or more metrics including at least one of usefulness, relevance, performance, actionability, timeframe.

13. The system of claim 9, wherein the score allocated to the one or more widgets is stored in a database.

14. The system of claim 9, wherein the processor is configured to render the dashboard layout with the one or more widgets having a high score at top and center of the dashboard layout and the one or more widgets having a low score at bottom of the dashboard layout.

15. The system of claim 9, wherein the processor is configured to render a dashboard user interface (UI) comprising the dashboard layout.

16. The system of claim 9, wherein the profile of the user is stored in a database.

17. A non-transitory computer-readable storage medium, storing program instructions for rendering a dashboard layout to a user in a business enterprise, the program instructions, when executed, perform the steps of:
receiving authentication credentials from the user;
retrieving a profile of the user based on the authentication credentials, wherein the profile includes at least one of a user identifier, an identifier of the business enterprise, a role of the user in the business enterprise;
identifying one or more widgets based on the profile of the user;
retrieving data associated with the one or more widgets, wherein the data for each of the one or more widgets comprises at least one of a user preference rating, information on historical interactions, a score based on historical data;
selecting the one or more widgets based on a combination of the profile of the user and the data associated with the one or more widgets;
dynamically rendering the dashboard layout with the selected widgets.

18. The non-transitory computer-readable storage medium as claimed in claim 17, storing program instructions, the program instructions, when executed, perform the step of:
updating the score associated with the one more widgets based on a current action of the user on the dashboard layout in real time.

19. The non-transitory computer-readable storage medium as claimed in claim 17, storing program instructions, the program instructions, when executed, perform the step of:
rendering the dashboard layout with the one or more widgets having a high score at top and center of the dashboard layout and the one or more widgets having a low score at bottom of the dashboard layout.

20. The non-transitory computer-readable storage medium as claimed in claim 17, storing program instructions, the program instructions, when executed, perform the step of:
rendering a dashboard user interface (UI) comprising the dashboard layout.
